(19) United States
(12) Patent Application Publication
(10) Pub. No.: US 2010/0295353 A1
(43) Pub. Date: Nov. 25, 2010

(54) FOLD AND KNEEL SEAT ASSEMBLY WITH STAND UP MECHANISM

(76) Inventor: Omar D. Tame, West Bloomfield, MI (US)

Correspondence Address: MAGNA INTERNATIONAL, INC., 337 MAGNA DRIVE, AURORA, ON, L4G-7K1, CA

(21) Appl. No.: 12/812,517

(22) PCT Filed: Jan. 26, 2009
(86) PCT No.: PCT/CA2009/000071

§ 371 Date: Jul. 12, 2010

Related U.S. Application Data
(60) Provisional application No. 61/023,900, filed on Jan. 28, 2008.

(51) Int. Cl. B60N 2/30

(52) U.S. Cl. 297/340

(57) ABSTRACT

A seat assembly including a seat back and seat cushion has a linkage system for moving the seat assembly between a seating position, a stowed position, and a stand-up position. The linkage system includes a support link and a drive link. The drive link urges the seat cushion between a raised position and a lowered position in response to pivoting the seat back from an upright position to a folded position. The drive link also urges a seat back bracket to pivot about a rearward end of the support link to maintain the seat back in a generally vertical orientation in response to pivoting the support link about a forward end, which pivots the seat cushion between the raised position and a generally vertical position.

### CROSS-REFERENCE TO RELATED APPLICATION

This application claims priority to and all the benefits of U.S. Provisional Application No. 61/023,900, filed on Jan. 28, 2008 and entitled “Fold And Kneel Seat Assembly With Stand Up Mechanism.”

### BACKGROUND OF THE INVENTION

1. Field of the Invention

The invention relates to a seat assembly for an automotive vehicle. More particularly, the invention relates to a seat assembly that is movable between a seating position, a stand-up position, and at least one stowed position.

2. Description of Related Art

It is common in certain mini-van and sport utility vehicles to provide third row seating. Typically, the vehicle includes a pair of front doors adjacent front row seating and a pair of rear doors located adjacent second row seating. The third row seating is located at the generally furthermost rear portion of the vehicle and is not located adjacent a door opening. Thus, passengers do not have direct access to the third row seating.

To provide access to the third row seating or a rear storage area, it is well known that the second row seating may have a releasable seat back locking mechanism which is capable of being manually actuated in order to pivot the seat back forwardly to an access position. A passenger can then enter the vehicle through one of the rear doors, moving past the second row seating, to gain access to the third row seating or the rear storage area.

Optionally, the second row seating may be movable to a tumbled position adjacent the front row seating, such as disclosed in U.S. Pat. No. 6,135,555 to Liu et al. In Liu et al. a seat back of the second row seating is first folded forward until it is flat against a seat cushion of the second row seating. Second, both the seat back and seat cushion are pivoted approximately ninety degrees (90°) about a pivot point at a lower front edge of the seat cushion until the seat back and seat cushion are substantially upright. In this position, the seat back of the second row seating is disposed adjacent to a back side of the front row seating. The passenger can then enter the vehicle moving past the tumbled second row seating. However, movement of the second row seating in this manner can be difficult for some passengers, and the passageway for ingress and egress is often uncomfortably small for other passengers.

In order to provide better access to the third row seating it has been proposed to move the second row seating to a stand-up position, such as disclosed in U.S. Pat. No. 6,676,216 to Freijy et al. In Freijy et al., a seat cushion pivots forward about a pivot point at a lower front edge from a generally horizontal position for supporting a seat occupant to a generally vertical position. At the same time a seat back moves from a first vertical position for supporting a back of the seat occupant to a second vertical position forward and upward of the first vertical position. The seat back and seat cushion move dependently due to a linkage therebetween. However, the second row seating disclosed in Freijy et al. is not movable to a stowed or kneeling position wherein the seat back is folded forward overlying the seat cushion and the seat cushion is lowered against the floor. The stowed position is desirable for increasing the available cargo space in the rear storage area of the vehicle.

Typically, in seat assemblies that are movable to a stowed position, the seat back is pivotally coupled to the seat cushion at a seat back pivot located between a lower end of the seat back and a rear end of the seat cushion. The seat back pivot allows the seat back to pivot between a generally upright position and a forwardly folded position overlying the seat cushion. The seat cushion often includes a four-bar-linkage or front and rear legs pivotally coupled between the seat cushion and the floor of the vehicle for moving the seat cushion between a raised position spaced above the floor and a lowered position resting along the floor. In the stowed position the seat cushion is in the lowered position and the seat back is in the forwardly folded position. Thus, when the seat assembly is in the stowed position a back side of the seat back is generally horizontal and defines a load floor surface.

It is therefore desirable to provide a seat assembly that is movable between a seating position and a stand-up position in order to improve access to a rearward row of seating or a storage area behind the seat assembly. Is also desirable that the seat assembly be movable to a stowed position in order to increase the amount of storage space in the vehicle.

### SUMMARY OF THE INVENTION

According to one aspect of the invention, a seat assembly is provided for supporting an occupant above a floor in an automotive vehicle. The seat assembly includes a seat back and a seat cushion that extends between a front end and a rear end. The seat assembly also includes a linkage system for moving the seat assembly between a seating position, a stowed position, and a stand-up position. A front link is pivotally coupled between the front end of the seat cushion and the floor. A support link extends between a forward end that is adapted to be pivotally coupled to the floor and a rearward end. A seat back bracket extends between upper and lower ends. The upper end is operatively coupled to the seat back for allowing selective pivotal movement of the seat back between a first upright position and a forwardly folded position. The lower end is pivotally coupled to the rearward end of the support link. A drive link extends between a first end pivotally coupled to the seat cushion and a second end pivotally coupled to the seat back. The drive link urges the seat cushion between a raised position and a lowered position, forward and downward of the raised position, in response to pivoting the seat back between the first upright position and the forwardly folded position. Additionally, the drive link urges the seat back bracket to pivot about the lower end to maintain the seat back in a generally vertical orientation in response to pivoting the support link about the forward end, which pivots the seat cushion between the raised position and a generally vertical position.

### BRIEF DESCRIPTION OF THE DRAWINGS

Other advantages of the present invention will be readily appreciated as the same becomes better understood by reference to the following detailed description when considered in connection with the accompanying drawings, wherein:

FIG. 1 is a side view of a seat assembly according to the invention in a seating position;

FIG. 2 is a side view of the seat assembly in a first stowed position;

FIG. 3 is a side view of the seat assembly in a stand-up position;

FIG. 4 is a side view of the seat assembly illustrating a seat back in a first upright position and a seat cushion in a generally vertical position providing access to under-seat storage;

FIG. 5 is a side view of the seat assembly in a second stowed position; and

FIG. 6 is a fragmentary, rear perspective view of the seat assembly in the stand-up position illustrating under-seat storage.

### DETAILED DESCRIPTION OF THE EMBODIMENTS

Referring to the Figures, wherein like numerals indicate like or corresponding parts throughout the several views, a seat assembly for use in an automotive vehicle is generally shown at 10. The seat assembly 10 includes a seat cushion 12 for supporting a seat occupant above a floor 14 of the vehicle. The seat assembly 10 also includes a seat back 16 operatively coupled to the seat cushion 12 for supporting a back of the seat occupant. Each one of the seat cushion 12 and the seat back 16 include a rigid frame structure supporting a resilient contoured foam pad that is encased by a fabric trim cover, as is commonly known in the vehicle seating art. The seat cushion 12 extends between a front end 18 and a rear end 20. The seat back 16 extends between a lower end 22 and an upper end 24.

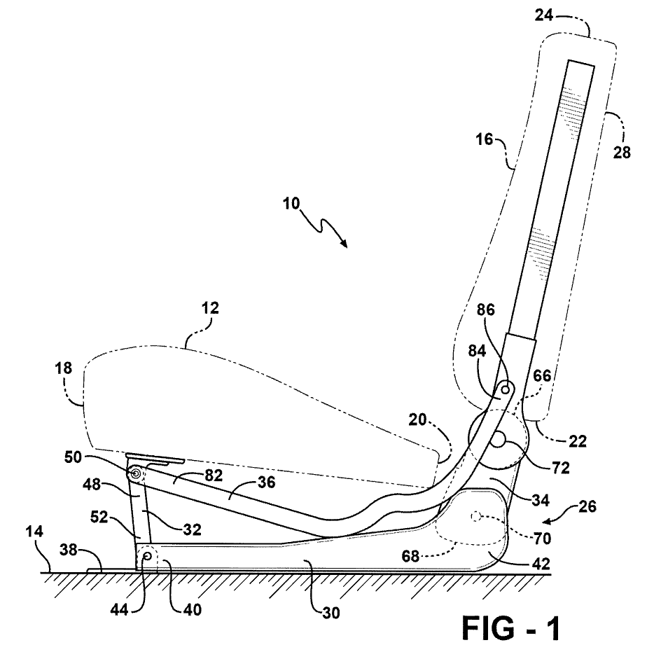

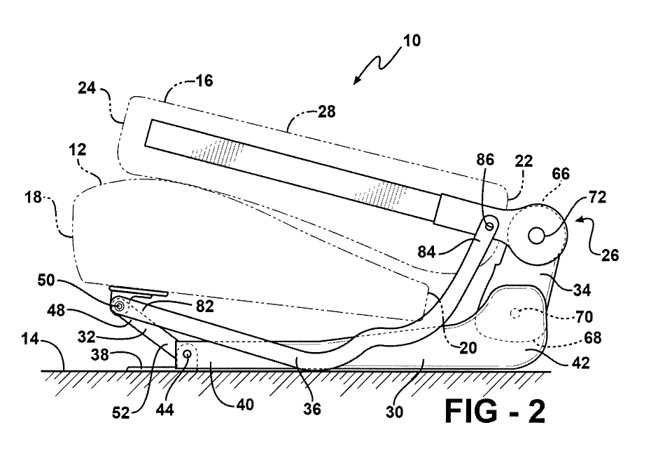

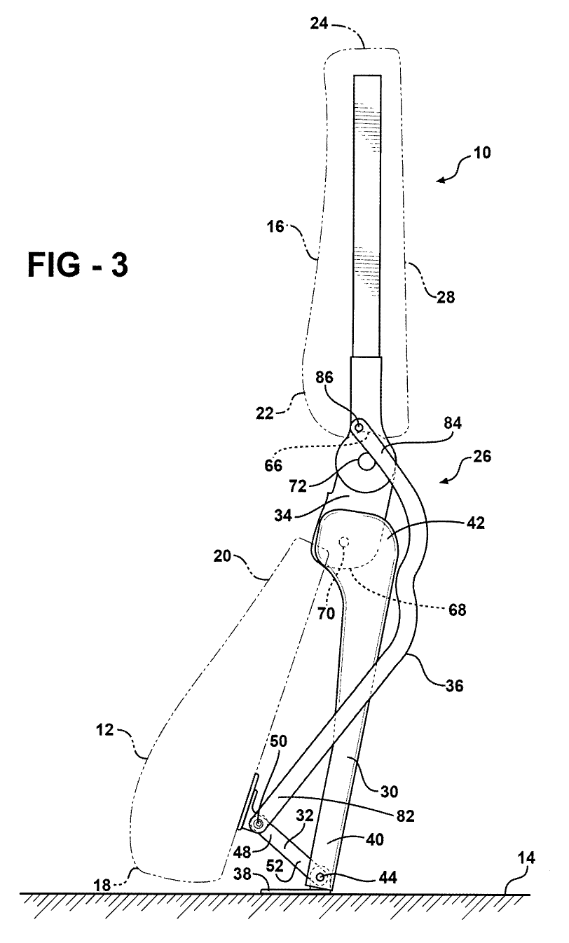

A linkage system, generally shown at 26, is provided for supporting the seat cushion 12 and seat back 16 above the floor 14 of the vehicle. The linkage system 26 is operable for moving the seat assembly 10 between a seating position, shown in FIG. 1, a kneeling or first stowed position, shown in FIG. 2, and a stand-up position, shown in FIG. 3. In the seating position, the seat cushion 12 is in a first generally horizontal position, raised above the floor 14 and the seat back 16 is in a first upright position. In the first stowed position, the seat cushion 12 is in a second generally horizontal position, lying adjacent to the floor 14, and the seat back 16 is in a forwardly folded position, overlying the seat cushion 12. With the seat back 16 in the forwardly folded position a back side 28 of the seat back 16 defines a generally horizontal load floor surface. It is appreciated that additional storage space is provided within the vehicle when the seat assembly 10 is in the first stowed position.

In the stand-up position, shown in FIG. 3, the seat cushion 12 is flipped forwardly to a generally vertical position such that the rear end 20 of the seat cushion 12 is positioned above the front end 18 of the seat cushion 12. In the stand-up position the seat back 16 is in a second upright position, disposed forward and upward relative to the first upright position. It is appreciated that the stand-up position of the seat assembly 10 provides improved ingress and egress to an area behind the seat assembly 10 and provides additional storage space behind the seat assembly 10 if left in the stand-up position.

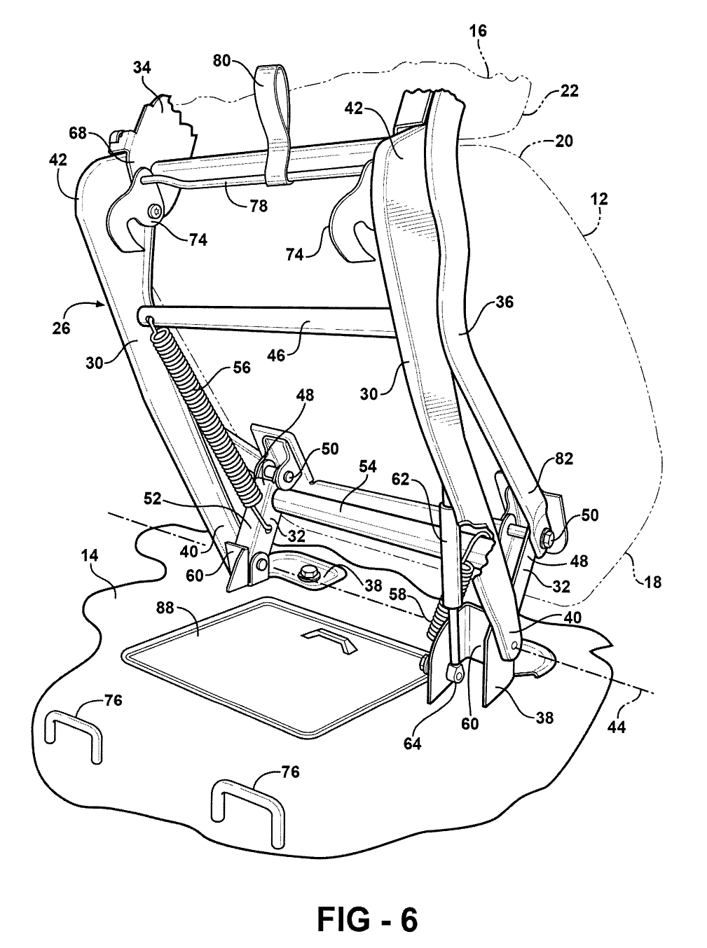

Referring to FIGS. 1 through 6, the linkage system 26 includes a pair of laterally spaced apart support links 30, a pair of laterally spaced apart front links 32, a pair of laterally spaced apart seat back brackets 34, and a pair of laterally spaced apart drive links 36. While the linkage system 26 is shown to include pairs of each of the respective components listed above, it is appreciated that only one of each component is required. A pair of laterally spaced apart forward floor brackets 38 is adapted to be fixedly secured to the floor 14 of the vehicle using bolts or similar fasteners. Each one of the support links 30 is elongated and extends between a first or forward end 40 and a second or rearward end 42. The forward end 40 of each one of the support links 30 is pivotally coupled to one of the forward floor brackets 38, thereby pivotally securing the seat assembly 10 to the floor 14 about a laterally extending pivot axis 44. A first cross bar 46, best seen in FIG. 6, extends laterally between the support links 30 approximately midway between the forward 40 and rearward 42 ends thereof. The first cross bar 46 acts as a brace between the support links 30, providing structural rigidity to the seat assembly 10.

Each one of the front links 32 is pivotally coupled between the seat cushion 12 and one of the floor brackets 38. More specifically, each one of the front links 32 extends between an upper end 48 pivotally coupled to the front end 18 of the seat cushion 12 at pivot 50 and a lower end 52 pivotally coupled to one of the forward floor brackets 38 at the pivot axis 44. A second cross bar 54, best seen in FIG. 6, extends laterally between the front links 32, near the upper end 48 thereof. The second cross bar 54 acts as a brace between the front links 32, providing added structural rigidity to the seat assembly 10. In the embodiment shown, on one side of the seat assembly 10 a first spring 56 extends between the first cross bar 46 and the corresponding front link 32. On the other side of the seat assembly 10 a second spring 58 extends between the second cross bar 54 and the corresponding floor bracket 38. Each one of the floor brackets 38 includes an integral stop 60 which the corresponding front link 32 abuts when the seat cushion 12 is in the first raised position and the seat assembly 10 is in the seating position. The first 56 and second 58 springs bias the seat cushion 12 to the first raised position.

A damping strut 62 is provided to assist with movement of the seat assembly 10 between the seating position and the stand-up position. In the embodiment shown, the damping strut 62 is provided on the same side of the seat assembly 10 as the second spring 58 and extends between the floor bracket 38 and the support link 30. More specifically, the damping strut 62 is pivotally coupled to the floor bracket 38 at pivot 64 and is pivotally coupled to the support link 30 at a position between the first cross bar 46 and the forward end 40.

Each one of the seat back brackets 34 extends between an upper end 66 and a lower end 68. The lower end 68 of each one of the seat back brackets 34 is pivotally coupled to the rearward end 42 of one of the support links 30 at pivot 70. A pair of pivot mechanisms 72 is operatively coupled between the seat back 16 and the seat back brackets 34 to control pivotal movement of the seat back 16. More specifically, each one of the pivot mechanisms 72 is operatively coupled between the lower end 22 of the seat back 16 and the upper end 66 of one of the seat back brackets 34 defining a seat back pivot. The pivot mechanisms 72 actuate together between a locked state, locking the seat back 16 in the first upright position, and an unlocked state, allowing pivotal movement of the seat back 16 between the first upright position and the forwardly folded position. A release handle (not shown) is provided for actuating the pivot mechanisms 72 from the locked state to the unlocked state. The pivot mechanisms 72 can be any mechanism suitable for controlling pivotal movement of the seat back 16 between the first upright position and the forwardly folded position, without varying from the scope of the invention.

The lower end 68 of each one of the seat back brackets 34 is adapted to be releasably secured to the floor 14. More specifically, the lower end 68 of each one of the seat back brackets 34 includes a latch mechanism 74, best seen in FIG. 6, for releasably securing the seat assembly 10 to the floor 14. The latch mechanisms 74 actuate together between a latched state and an unlatched state. In the latched state, each latch mechanism 74 is engaged with a corresponding striker bar 76 mounted to the floor 14. In the unlatched state, each latch mechanism 74 is disengaged with the corresponding striker bar 76 to allow the seat assembly 10 to move between the seating position and the stand-up position. The latch mechanisms 74 are operatively coupled together by a cross-talk tube 78 extending therebetween. A strap 80 is coupled to the cross-talk tube 78 for simultaneously actuating the latch mechanisms 74 from the latched state to the unlatched state. Alternatively, it is contemplated that the rearward end 42 of each one of the support links 30 may include the latch mechanism 74 for releasably securing the seat assembly 10 to the floor 14, without varying from the scope of the invention.

In the embodiment shown, each one of the drive links 36 extends non-linearly between a first end 82 and a second end 84. The first end 82 of each one of the drive links 36 is pivotally coupled to the front end 18 of the seat cushion 12 at pivot 50. The second end 84 of each one of the drive links 36 is pivotally coupled to the seat back 16 at pivot 86. It is appreciated that the drive links 36 may be any shape extending between the seat cushion 12 and the seat back 16, without varying from the scope of the invention.

In operation, beginning with the seat assembly 10 in the seating position the pivot mechanisms 72 are actuated from the locked state to the unlocked state by operating the release handle. With the pivot mechanisms 72 in the unlocked state the seat back 16 is free to pivot about the seat back pivot from the first upright position to the forwardly folded position. As the seat back 16 pivots in a counterclockwise direction (when viewed from FIG. 1) the lower end 22 of the seat back 16 urges the drive links 36 forward and downward. The forward and downward movement of the drive links 36 cause the front links 32 to pivot in the counterclockwise direction about the pivot axis 44. As the front links 32 pivot in the counterclockwise direction, the seat cushion 12 moves forward and downward from the first raised position to the second lowered position. With the seat cushion 12 in the second lowered position and the seat back 16 in the forwardly folded position the seat assembly 10 is in the first stowed position, as shown in FIG. 2.

To return the seat assembly 10 from the first stowed position to the seating position, the upper end 24 of the seat back 16 is lifted causing the seat back 16 to pivot about the seat back pivot from the forwardly folded position to the first upright position. As the seat back 16 pivots in a clockwise direction (when viewed from FIG. 2), the lower end 22 of the seat back 16 urges the drive links 36 upward and rearward. The upward and rearward movement of the drive links 36 cause the front links 32 to pivot in the clockwise direction about the pivot axis 44. As the front links 32 pivot in the clockwise direction, the seat cushion 12 moves upward and rearward from the second lowered position to the first raised position. With the seat cushion 12 in the first raised position and the seat back 16 in the first upright position the seat assembly 10 is in the seating position and the pivot mechanisms 72 return to the locked state. It is appreciated that during movement of the seat assembly 10 between the seating position and the first stowed position the rear end 20 of the seat cushion 12 is not coupled to the rearward end 42 of the support links 30.

Beginning again with the seat assembly 10 in the seating position the latch mechanisms 74 are actuated from the latched state to the unlatched state by pulling the strap 80, thereby disengaging the latch mechanisms 74 with the striker bars 76. The support links 30 are now free to pivot in the counterclockwise direction (when viewed from FIG. 1) about the pivot axis 44. As the support links 30 pivot in the counterclockwise direction, the front links 32 also pivot in the counterclockwise direction about the pivot axis 44 thereby moving the seat cushion 12 from the first raised position to the generally vertical position. At the same time, the drive links 36 pivot in the counterclockwise direction about pivot 50. As the drive links 36 pivot in the counterclockwise direction, the second end 84 of each one of the drive links 36 urges the seat back 16 and the seat back brackets 34 to pivot in the clockwise direction about pivot 70 relative to the seat cushion 12, thereby moving the seat back 16 from the first upright position to the second upright position. With the seat cushion 12 in the generally vertical position and the seat back 16 in the second upright position, the seat cushion 12 and seat back 16 are generally vertically aligned and the seat assembly 10 is in the stand-up position, as shown in FIG. 3.

To return the seat assembly 10 from the stand-up position to the seating position, the upper end 24 of the seat back 16 is pushed rearwardly, which causes the support links 30 to pivot in the clockwise direction about the pivot axis 44. As the support links 30 pivot in the clockwise direction, the front links 32 also pivot in the clockwise direction about the pivot axis 44 thereby moving the seat cushion 12 from the generally vertical position to the first raised position. The support links 30 pivot in the clockwise direction about the pivot axis 44 until the latch mechanisms 74 re-engage with the corresponding striker bars 76. At the same time, the drive links 36 pivot in the clockwise direction about pivot 50. As the drive links 36 pivot in the clockwise direction, the second end 84 of each one of the drive links 36 urges the seat back 16 and the seat back brackets 34 to pivot in the counterclockwise direction about pivot 70 relative to the seat cushion 12, thereby moving the seat back 16 from the second upright position to the first upright position. With the seat cushion 12 in the first raised position and the seat back 16 in the first upright position, the seat assembly 10 is in the seating position. Although not shown in the Figures, it is contemplated that the rear end 20 of the seat cushion 12 may be coupled to the rearward end 42 of the support links 30 to ensure that the seat cushion 12 and the support links 30 pivot together as the seat assembly 10 moves between the seating position and the stand-up position.

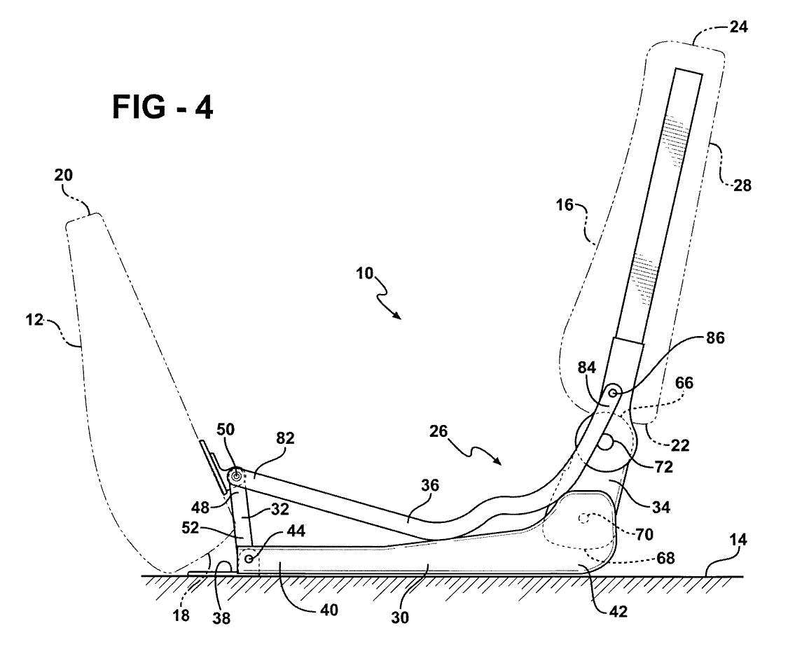

When the seat assembly 10 is in the seating position, the seat cushion 12 can be flipped forwardly about pivot 50, as shown in FIG. 4. The seat cushion 12 is flipped forwardly to allow access to an area below the seat assembly 10. It is contemplated that a tray or lockable compartment 88, best seen in FIG. 6, may be provided in the area below the seat cushion 12 for storing a plurality of items therein. It is appreciated that the rear end 20 of the seat cushion 12 may be lockable to the rearward end 42 of the support links 30 to prevent the seat cushion 12 from being flipped forward in order to restrict access to the lockable compartment 88.

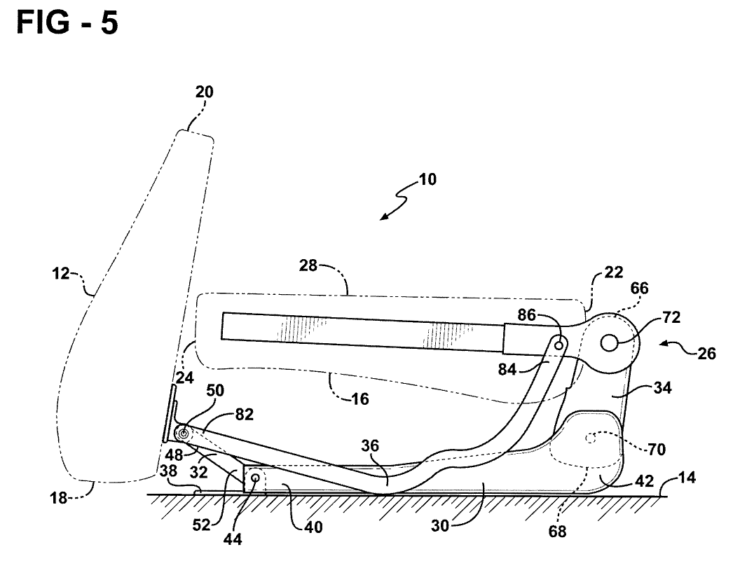

The seat assembly 10 is also movable between the seating position and a second stowed position, as shown in FIG. 5. In order to move the seat assembly 10 from the seating position to the second stowed position, the seat cushion 12 is pivoted in the counterclockwise direction (when viewed from FIG. 1) about pivot 50 until the seat cushion 12 is in the generally vertical position, such that the rear end 20 of the seat cushion 12 is positioned above the front end 18 of the seat cushion 12, similar to the position of the seat cushion 12 when the seat assembly 10 is in the stand-up position. Next, the pivot mechanisms 72 are actuated from the locked state to the unlocked state by operating the release handle. With the pivot mechanisms 72 in the unlocked state the seat back 16 is free to pivot about the seat back pivot from the first upright position to a fold flat position. It is noted that the fold flat position is similar to the forwardly folded position of the seat back 16 when the seat assembly 10 is in the first stowed position except that a front seating surface of the seat back 16 may be disclosed closer to the floor 14 because the seat back 16 does not contact the seat cushion 12. As the seat back 16 pivots in the counterclockwise direction (when viewed from FIG. 1) the lower end 22 of the seat back 16 urges the drive links 36 forward and downward. The forward and downward movement of the drive links 36 cause the front links 32 to pivot in the counterclockwise direction about the pivot axis 44. As the front links 32 pivot in the counterclockwise direction, the seat cushion 12 moves slightly forward and downward to provide clearance for the upper end 24 of the seat back 16 to allow the seat back 16 to pivot into the fold flat position. With the seat cushion 12 in the generally vertical position and the seat back 16 in the fold flat position, the seat assembly 10 is in the second stowed position.

The invention has been described here in an illustrative manner, and it is to be understood that the terminology used is intended to be in the nature of words of description rather than limitation. Many modifications and variations of the present invention are possible in light of the above teachings. It is, therefore, to be understood that within the scope of the appended claims, the invention may be practiced other than as specifically enumerated within the description.

What is claimed:

1. A seat assembly for supporting an occupant above a floor in an automotive vehicle, said seat assembly comprising:
a seat back;
a seat cushion extending between front and rear ends, said seat cushion including a front link adapted to be pivotally coupled to the floor for moving said seat cushion between a generally horizontal seating position raised above the floor, a generally horizontal stowed position forward and downward of said seating position and adjacent the floor, and a generally vertical position wherein said rear end is disposed above said front end;
a support link extending between a forward end adapted to be pivotally coupled to the floor and a rearward end;
a seat back bracket extending between an upper end and a lower end, said upper end operatively coupled to said seat back for allowing selective pivotal movement of said seat back between a first upright position and a generally horizontal forwardly folded position, said lower end pivotally coupled to said rearward end of said support link; and
a drive link extending between a first end pivotally coupled to said seat cushion and a second end pivotally coupled to said seat back, wherein said drive link urges said seat cushion between said seating position and said stowed position in response to pivoting said seat back between said first upright position and said forwardly folded position, and wherein said drive link urges said seat back bracket to pivot about said lower end relative to said support link to maintain said seat back in a generally vertical orientation in response to pivoting said support link about said forward end which pivots said seat cushion between said seating position and said generally vertical position.

2. A seat assembly as set forth in claim 1 wherein said drive link urges said seat back to move about an arcuate path between said first upright position and a second upright position forward and upward of said first upright position in response to pivoting said support link about said forward end.

3. A seat assembly as set forth in claim 2 wherein said lower end of said seat back bracket includes a latch mechanism for releasably securing said seat assembly to the floor.

4. A seat assembly as set forth in claim 3 wherein said latch mechanism is operable between a latched state adapted to be engaged with the floor and an unlatched state adapted to be disengaged with the floor.

5. A seat assembly as set forth in claim 4 wherein said latch mechanism is in said latched state when said seat cushion is in said seating and stowed positions.

6. A seat assembly as set forth in claim 5 wherein said latch mechanism is in said unlatched state when said support link is pivoted about said forward end.

7. A seat assembly as set forth in claim 6 further including a pivot mechanism disposed between said seat back and said upper end of said seat back bracket for controlling said selective pivotal movement of said seat back, wherein said pivot mechanism is operable between a locked state locking said seat back to prevent pivotal movement relative to said seat back bracket and an unlocked state allowing pivotal movement of said seat back between said first upright position and said forwardly folded position.

8. A seat assembly as set forth in claim 7 wherein said pivot mechanism is in said locked state when said drive link urges said seat back to move between said first upright position and said second upright position.

9. A seat assembly as set forth in claim 8 wherein said front link extends between an upper end pivotally coupled to said front end of said seat cushion at a first pivot and a lower end adapted to be pivotally coupled to the floor defining a pivot axis.

10. A seat assembly as set forth in claim 9 wherein said first end of said drive link is pivotally coupled to said seat cushion at said first pivot.

11. A seat assembly as set forth in claim 10 wherein said forward end of said support link is adapted to be pivotally coupled to the floor at said pivot axis.

12. A seat assembly as set forth in claim 11 wherein said seat cushion is movable between said seating position and said generally vertical position wherein said rear end is disposed above said front end to allow access to under-seat storage.

13. A seat assembly as set forth in claim 12 wherein said pivot mechanism is operable to said unlocked state to allow said seat back to pivot relative to said seat back bracket between said first upright position and a fold flat position when said seat cushion is in said generally vertical position.

14. A seat assembly for supporting an occupant above a floor in an automotive vehicle, said seat assembly comprising:
a seat cushion extending between front and rear ends, said front end of said seat cushion adapted to be pivotally coupled to the floor for movement of said seat cushion between a first generally horizontal position raised above the floor, a second generally horizontal position forward and downward of said first generally horizontal position, and a generally vertical position wherein said rear end is disposed above said front end;
a support link extending between a forward end adapted to be pivotally coupled to the floor and a rearward end, wherein pivotal movement of said support link about said forward end pivots said seat cushion between said first generally horizontal position and said generally vertical position;
a seat back operatively coupled to said rearward end of said support link; and
a drive link extending between a first end pivotally coupled to said seat cushion and a second end pivotally coupled to said seat back, wherein said drive link urges said seat cushion between said first generally horizontal position and said second generally horizontal position in response to selective pivotal movement of said seat back between a first generally upright position and a forwardly folded position, and wherein said drive link pivots said seat back relative to said support link to maintain said seat back in a generally vertical orientation in response to pivoting said support link about said forward end.

15. A seat assembly as set forth in claim 14 further including a seat back bracket extending between an upper end and a lower end, said seat back operatively coupled to said upper end of said seat back bracket for allowing said selective pivotal movement of said seat back between said first generally upright position and said forwardly folded position, and said lower end of said seat back bracket is pivotally coupled to said rearward end of said support link.

16. A seat assembly as set forth in claim 15 wherein said lower end of said seat back bracket includes a latch mechanism for releasably securing said seat assembly to the floor, wherein said latch mechanism is in said latched state when said seat cushion is in said first and second generally horizontal positions, and wherein said latch mechanism is in said unlatched state to allow said support link to pivot about said forward end.

17. A seat assembly as set forth in claim 16 further including a pivot mechanism disposed between said seat back and said upper end of said seat back bracket for controlling said selective pivotal movement of said seat back, wherein said pivot mechanism is operable between a locked state locking said seat back to prevent pivotal movement relative to said seat back bracket and an unlocked state allowing pivotal movement of said seat back between said first upright position and said forwardly folded position.

18. A seat assembly as set forth in claim 17 wherein said pivot mechanism is in said locked state when said seat back pivots in response to pivoting said support link about said forward end.
